(19) United States
(12) Patent Application Publication
(10) Pub. No.: US 2026/0364685 A1
(43) Pub. Date: Nov. 19, 2026

(54) DETACHABLE BUILD PLATE

(71) Applicant: SECO TOOLS AB, Fagersta (SE)

(72) Inventors: Ville-Pekka MATILAINEN, Fagersta (SE); Filip JOHANSSON, Fagersta (SE); Thomas ACHREN, Fagersta (SE)

(21) Appl. No.: 19/143,036

(22) PCT Filed: Dec. 14, 2023
(86) PCT No.: PCT/EP2023/085893

§ 371 Date: Jun. 25, 2025

(30) Foreign Application Priority Data
Dec. 29, 2022 (SE) 2230446-3

(51) Int. Cl. B22F 12/30; B33Y 30/00

(52) U.S. Cl. CPC B22F 12/30; B33Y 30/00

(57) ABSTRACT

A detachable build plate for additive manufacturing is arranged to be inserted into a recess of a bottom plate. The detachable build plate includes a build area for additively manufacturing thereon. A combined build plate including the detachable build plate and a a bottom plate including a first recess arranged for receiving the detachable build plate is also provided.

### TECHNICAL FIELD

The present disclosure relates generally to a build plate, more specifically to a build plate for additive manufacturing.

### BACKGROUND

Additive manufacturing, also known as 3D printing, generally involves printing an article one layer at a time using specialized systems. In particular, a layer of material may be deposited on a working surface, such as a build plate, of a build chamber and bonded with another layer of the same or of a different material. Additive manufacturing may be used to manufacture articles from computer-aided design models using techniques such as powder bed fusion (PBF) and binder jetting.

When switching from manufacturing one article to manufacturing the next article, the build plate of the additive manufacturing device generally needs to be switched, or at least the manufactured article needs to be removed from the build plate, which usually entails removing the build plate from the build chamber in order to remove the manufactured article.

In some applications, additive manufacturing may be used to manufacture an article on top of a pre-manufactured base device, often referred to as a blank, and such articles are often referred to as hybrid articles. The base device may be intended to be a part of the finished article.

When manufacturing hybrid articles, the article to be manufactured is generally not manufactured directly onto the build plate itself, but instead onto to the base device, which is positioned in some way on the build plate.

There are many types of different base devices used for manufacturing hybrid articles, of various shapes and sizes. The positioning of the base devices generally needs to be known very precisely and the margin of error is much lower than for other types of additive manufacturing, since a structure is to be manufactured on top of the base device rather than onto the build plate.

Since the base devices used in hybrid articles differ, it may be cumbersome to switch between manufacturing using different base devices. A build plate is generally only able to accommodate one type of base device, so if a different base device is to be used, the entire build plate needs to be switched.

It would be beneficial if additive manufacturing could be improved in order to make the process more efficient, especially when it comes to manufacturing multiple subsequent items.

### SUMMARY

It is an object of the invention to address at least some of the problems and issues outlined above. An object of embodiments of the invention is to provide a detachable build plate which can be inserted into a bottom plate, wherein the bottom plate may be either a part of a regular build plate, or part of an interface in an additive manufacturing device.

According to a first aspect, a detachable build plate for additive manufacturing is provided. The detachable build plate is adapted to be inserted into a recess of a bottom plate, wherein the detachable build plate comprises a build area for additively manufacturing thereon.

According to a second aspect, a combined build plate is provided. The combined build plate comprises a first detachable build plate according to the first aspect, as well as a bottom plate comprising a first recess adapted for receiving the detachable build plate.

Further possible features and benefits of this solution will become apparent from the detailed description below.

### BRIEF DESCRIPTION OF DRAWINGS

The solution will now be described in more detail by means of exemplary embodiments and with reference to the accompanying drawings, in which:

FIG. 1 shows a top side view of a detachable build plate according to an embodiment.

FIG. 2 shows an exploded view of a detachable build plate according to an embodiment.

FIG. 3 shows a cross sectional view of a detachable build plate according to an embodiment.

FIG. 4 shows a bottom side view of a detachable build plate according to an embodiment.

FIG. 5 shows a detachable build plate and a bottom plate, according to an embodiment.

FIG. 6 shows a bottom plate according to an embodiment.

FIG. 7 shows a detachable plate inserted into a bottom plate, according to an embodiment.

### DETAILED DESCRIPTION

Briefly described, the present solution relates to a detachable build plate, which is adapted to be inserted into a corresponding recess of a bottom plate.

Using a detachable build plate as described herein is especially suitable for manufacturing subsequent articles in the same additive manufacturing device, due to the detachable build plate only being a part of and thus a smaller size than a traditional build plate, which entails that that a smaller part needs to be moved in and out of the additive manufacturing device in between subsequent manufacturing processes.

Further, different detachable build plates may differ in features and characteristics, while still being adapted to be inserted into the same recess of a bottom plate. Thus, a combined build plate comprising a detachable build plate and a bottom plate according to the present disclosure may be modified for manufacturing different articles in different conditions in a much easier and faster way than traditional build plates.

For the purpose of this disclosure, the term “base device” is intended to denote a pre-made part onto which a structure is additively manufactured. Additively manufacturing an article on top of a pre-made part may also be referred to as hybrid manufacturing, or manufacturing hybrid articles. The base device may be adapted to form a part of the finished article, such that the finished article is constituted by the base device and the structure additively manufactured on the base device. The base device may for example be a drill and the article to be manufactured on top of the drill may be a drill tip. According to some embodiments, the base device is a generic machine interface, such as a Capto, HSK or similar, and the tool is a turning tool.

In some embodiments, the base device is made of steel or a similar alloy or metal material. In some embodiments, the powder used for manufacturing an article on top of the base device is a metallic powder or a cemented carbide powder.

The solution according to the present disclosure is especially suitable for manufacturing subsequent hybrid articles using different base devices, since the detachable build plate may comprise a seat adapted for a specific type and size of base device. Thus, when manufacturing a plurality of subsequent hybrid articles using base devices of different sizes and/or types, the detachable build plate used for manufacturing one hybrid article comprising a first type of base device can be removed and a detachable build plate adapted for a second type of base device can be inserted into the same recess as the previously used detachable build plate.

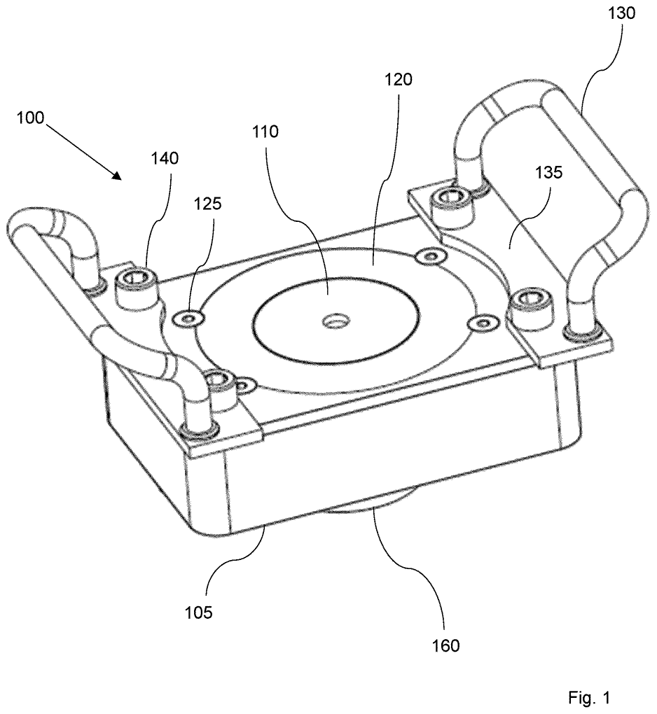

Looking now at FIG. 1, one embodiment of a detachable build plate 100 for additive manufacturing according to the present disclosure will now be described. The detachable build plate 100 is adapted to be inserted into a recess of a bottom plate, which will be further described later.

The detachable build plate 100 comprises a build area 110, onto which an article is intended to be additively manufactured. The build area 110 may in some embodiments be the surface of a base device, which is the case in the embodiment shown in FIG. 1, but it can also be a working surface used for manufacturing a non-hybrid article.

The detachable build plate 100 may further comprise a support plate 120, onto which a part of the article to be manufactured can be manufactured, or onto which a support structure for supporting the article manufactured on the build area 110 can be manufactured. The detachable build plate 100 may further comprise fastening means 125 for fastening the support plate 120 in the detachable build plate 100. The fastening means 125 may be in the form of a plurality screws, and the detachable build plate 100 may have pre-made holes for receiving such screws.

The detachable build plate 100 may further comprise gripping means 130 for gripping the detachable build plate 100, which may be used for inserting detachable build plate 100 into and extracting it from the recess of the bottom plate into which it is adapted to be inserted. The gripping means may in some embodiments be in the form of one or multiple handles, for example two handles 130 as shown in FIG. 1. In some embodiments, the gripping means 130 may be in the form of indentations, adapted to be gripped using e.g. a tool or a robotic arm. In some embodiments, the gripping means may be in the form of holes, which may be used for extracting the detachable plate with help of e.g. a threaded device such as a screw.

In some embodiments, the gripping means 130 are removable from the detachable build plate 100. The gripping means may be positioned on a plate 135 for making the removal and fastening of the gripping means 130 easier. The gripping means 130 may be fastened in the detachable build plate 100 by fastening means 140. In the embodiment shown in FIG. 1, each handle 130 and its respective plate 135 is fastened to the detachable build plate 100 by two screws 140.

The detachable build plate 100 may further comprise fixing means for fixing the detachable build plate 100 in the recess of a bottom plate. These fixing means may for example comprise holes in the detachable build plate 100 and screws adapted to be inserted into those holes, wherein the bottom plate has holes for receiving such screws.

In some embodiments, the detachable build plate 100 is rectangular in shape. In some embodiments, the detachable build plate may have other shapes as well, such as round.

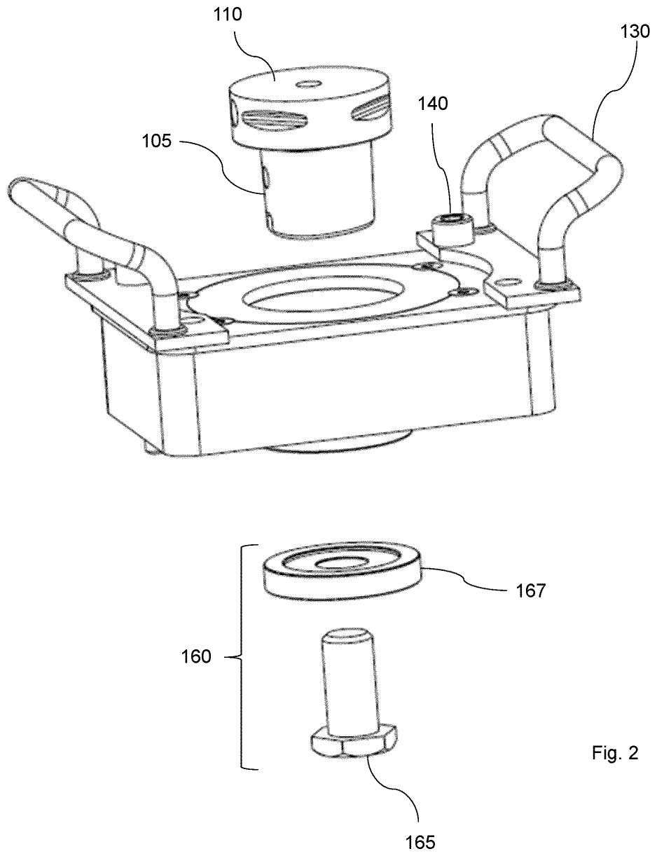

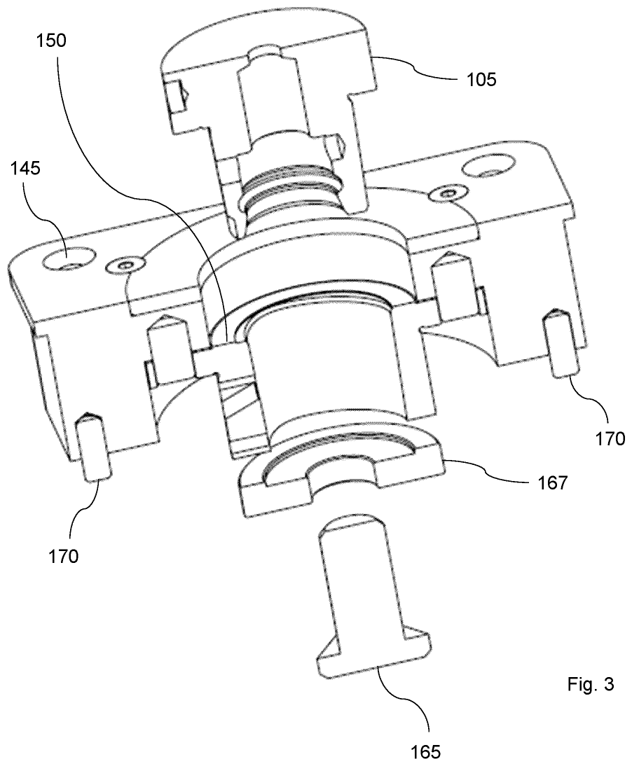

The solution will now be further described with further reference to FIGS. 2 and 3.

FIG. 2 shows an exploded view of a detachable build plate 100, a base device 105 and locking means 160. In FIG. 3, a cross-section of the exploded view of FIG. 2 is shown, without the handles 130.

FIG. 2 shows a base device 105, comprising a build area 110 onto which a structure is to be additively manufactured. The base device 105 is adapted to be inserted into the detachable build plate 100, more specifically into a seat 150 of the detachable build plate, shown in FIG. 3.

The seat 150 may be adapted to accommodate a base device of a certain type and/or size. Thus, by having a plurality of detachable build plates, each adapted for receiving a different type and/or size of base device, it becomes easy to manufacture a plurality of subsequent hybrid articles, each using a different base device, without having to exchange the entire build plate between each manufacturing process. Instead, only the detachable build plate 100 needs to be removed, and can be exchanged for a different detachable build plate with a seat 150 adapted for a different size and/or type of base device.

Further, it also becomes possible to have a plurality of detachable build plates 100 inserted into the same bottom plate, each into a different recess of the bottom plate. By having a bottom plate with a plurality of recesses for a plurality of detachable build plates 100, each detachable build plate preferably being of the same size, a plurality of hybrid articles can be manufactured simultaneously in a flexible way, which doesn't require the same combination of base devices each time.

In some embodiments the seat 150 may be adaptable, such that it is able to receive a plurality of different types and/or sizes of base devices.

In some embodiments, the detachable build plate 100 may comprise locking means 160 for locking the base device 105 in place when positioned in the seat 150 of the detachable build plate. In some embodiments, the fixing means 160 may comprise a bolt or screw 165 which is adapted to be inserted into the base device 105, and a washer 167. In some embodiments, the locking means 160 may be other than screws and bolts, such as hydraulic locking means.

FIG. 3 shows holes 145, which may be threaded, in which fastening means 140 for fastening the gripping means 130 may be inserted, especially if the fastening means 140 are in the form of screws.

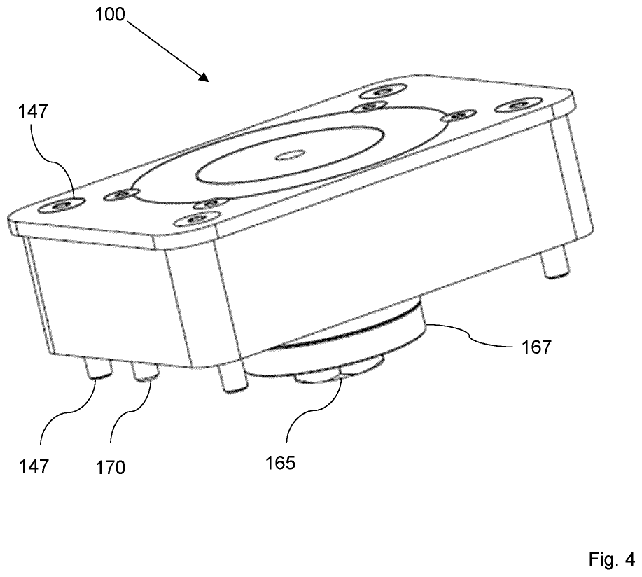

In some embodiments, the fixing means for fixing the detachable build plate 100 in the bottom plate may also be inserted into the same holes 145. In such embodiments, the handles may be removed from the detachable build plate 100 after it has been positioned in the bottom plate, and then fixing means in the form of screws can be inserted into the same holes. FIG. 4 shows a bottom side view of a detachable build plate 100 with fixing means 147 in the form of screws 147 inserted into the holes 145.

In some embodiments, the detachable build plate 100 comprises positioning pins 170, shown in FIG. 3, which are used for facilitating positioning of the detachable build plate 100 in the bottom plate. The bottom plate would then have corresponding recesses for receiving the positioning pins.

In some embodiments, wherein the detachable build plate is adapted for hybrid articles, the detachable build plate 100 is adapted such that the base device 110 is at the same level or slightly higher than the surrounding parts of the detachable build plate 100 when positioned in the seat 150.

Looking now at FIG. 4, another view of a detachable build plate 100 is shown, without handles but with fixing means 147 for fixing the detachable build plate 100 to a bottom plate.

The fixing means 147 shown in FIG. 4 are in the form of screws, which are inserted into holes 145 of the detachable build plate and which protrude from the detachable build plate on the bottom side, adapted to be inserted into corresponding receiving means of the bottom plate.

The positioning pins 170 as well as the fixing means 160 in the form of a bolt 165 and washer 167 are also shown in FIG. 4.

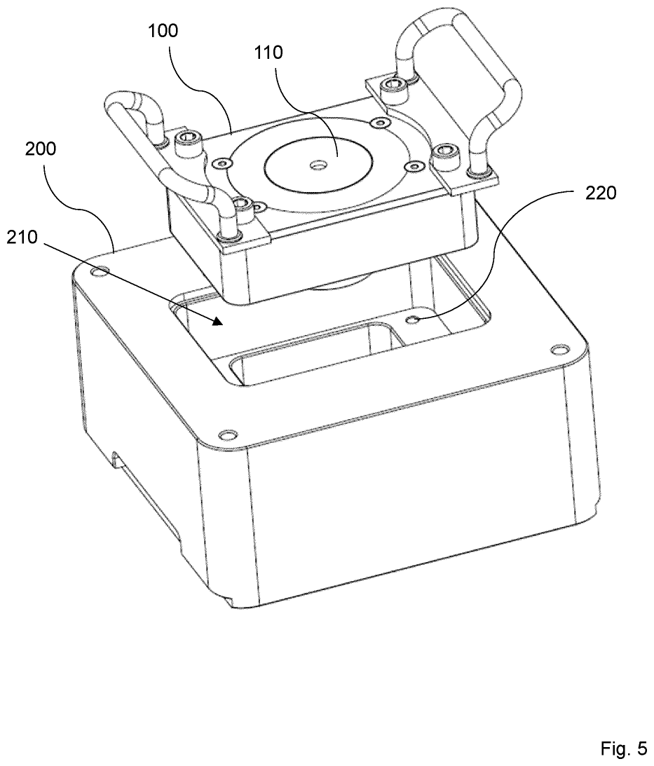

Looking now at FIG. 5, a detachable build plate 100 as well as a bottom plate 200 is shown.

The bottom plate 200 comprises a recess 210, adapted to receive a detachable build plate 100 according to the present disclosure. The bottom plate 200 may in some embodiments comprise receiving means 220 for receiving fixing means of the detachable build plate. In some embodiments, such as the one shown in FIG. 1, the receiving means 220 may be in the form of holes adapted to receive fixing means in the form of screws.

The bottom plate 200 may be a separate structure, intended to be positioned where a build plate is usually positioned in an additive manufacturing device, such that the detachable build plate 100 can be inserted into and extracted from the bottom plate 200, without the need to remove the bottom plate 200 from the additive manufacturing device in between manufacturing processes.

In some embodiments, the bottom plate 200 may be a part of an additive manufacturing device. Today, there is commonly an interface in an additive manufacturing device, in which a build plate is positioned. However, by using a detachable build plate 100 according to the present disclosure, it becomes possible to adapt the interface of an additive manufacturing device in a different way, such that it is adapted to receive a detachable build plate 100 rather than an entire build plate.

In some embodiments, the bottom plate 200 is rectangular. In some embodiments, the bottom plate 200 has the same shape as the detachable plate 100.

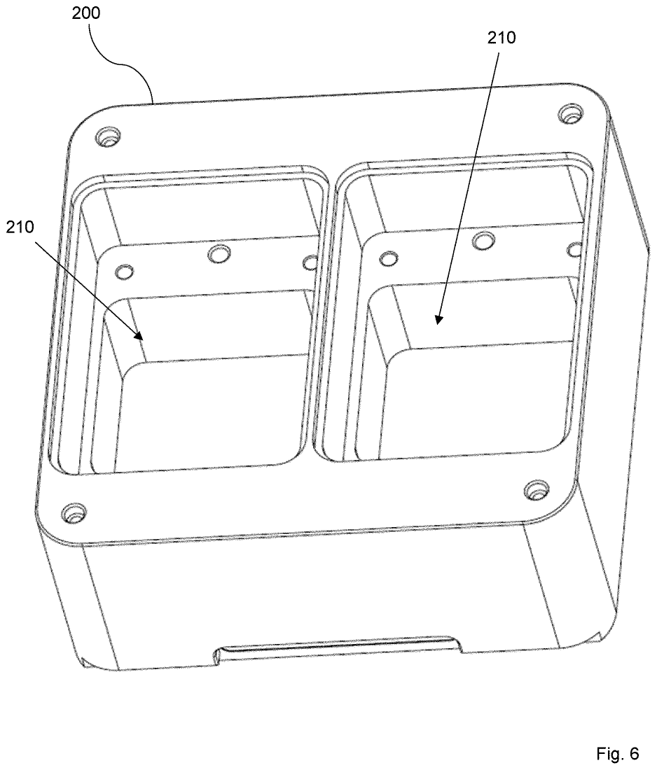

In some embodiments, the bottom plate 200 may comprise a plurality of recesses 210, each adapted to receive a detachable build plate 100. This is shown in FIG. 6, wherein the bottom plate 200 comprises two recesses 210. In such embodiments, a combined build plate comprising one bottom plate with a plurality of recess, and comprising a plurality of detachable build plates, each detachable build plate inserted into a respective recess may be achieved.

Preferably, in embodiments comprising a plurality of detachable build plates in one bottom plate, each recess of the bottom plate is of the same size and shape, and each detachable build plate is of the same exterior size and shape, in order to facilitate the modularity and the exchanging and switching between different detachable build plates in the same bottom plate. However, as previously described, even though the detachable build plates have the same exterior sizes and shapes, they may still be adapted for different sizes and/or types of base devices, e.g. by the seats in the detachable build plates being of different sizes.

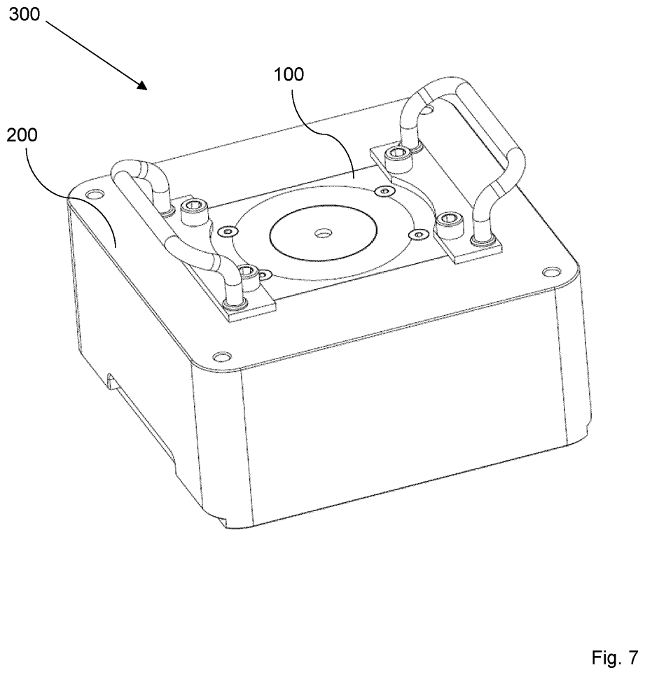

The combination of the detachable build plate 100 and the bottom plate 200 is intended to form a combined build plate 300, shown in FIG. 7, wherein the combined build plate 300 provides the same functionality as a regular build plate but with added benefits as described herein, such as modularity.

In some embodiments, the detachable build plate 100 and the bottom plate 200 are adapted such that the surface of the detachable build plate 100 is flush or substantially flush with the surface of the bottom plate 200, or at least with the surface of the bottom plate 200 immediately surrounding the detachable build plate 100, when the detachable build plate 100 is inserted in the bottom plate 200.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby. In the exemplary figures, a broken line generally signifies that the feature within the broken line is optional.

1. A detachable build plate for additive manufacturing arranged to be inserted into a recess of a bottom plate, comprising a build area for additively manufacturing thereon.

2. The detachable build plate according to claim 1, further comprising fixing means for fixing the detachable build plate to the bottom plate.

3. The detachable build plate according to claim 1, further comprising gripping means for gripping the detachable build plate.

4. The detachable build plate according to claim 1, further comprising at least one positioning pin for positioning the detachable build plate in the bottom plate.

5. The detachable build plate according to claim 1, further comprising a removable support plate.

6. The detachable build plate according to claim 1, further comprising a seat for receiving a base device for a hybrid article.

7. The detachable build plate according to claim 6, wherein the seat includes locking means for locking the base device in place.

8. A combined build plate comprising:
a first detachable build plate according to claim 1; and
a bottom plate including a first recess arranged for receiving the detachable build plate.

9. The combined build plate according to claim 8, further comprising a second recess arranged for receiving a second detachable build plate.

10. The combined build plate according to claim 9, wherein the first detachable build plate is arranged to receive a base device of a first size, and wherein the second detachable build plate is arranged to receive a base device of a second size, wherein the first size is different from the second size.
